(19) United States
(12) Patent Application Publication
(10) Pub. No.: US 2025/0158532 A1
(43) Pub. Date: May 15, 2025

(54) ISOLATED SWITCHED-MODE POWER SUPPLY AND SWITCHED-MODE POWER SUPPLY SYSTEM

(71) Applicant: SHANGHAI BRIGHT POWER SEMICONDUCTOR CO., LTD., Shanghai (CN)

(72) Inventors: Pengbo YANG, Shanghai (CN); Zhen ZHU, Shanghai (CN); Jia WANG, Shanghai (CN); Yanmei GUO, Shanghai (CN)

(21) Appl. No.: 18/949,375

(22) Filed: Nov. 15, 2024

(30) Foreign Application Priority Data
Nov. 15, 2023 (CN) 202323092246.X

(51) Int. Cl. H02M 3/335; H02M 1/44

(52) U.S. Cl. CPC H02M 3/33592; H02M 1/44

(57) ABSTRACT

The present invention relates to an isolated switched-mode power supply (SMPS) and an SMPS system. The isolated SMPS includes N (≥2) primary side circuits, N secondary side circuits, an isolated control module and N transformers. Each primary side circuit includes a power switch, and each secondary side circuit includes a synchronous rectifier. The isolated control module includes a primary side control module, an optocoupler and a secondary side control module, and is adapted to generate, based on output voltage signal and winding voltage signals from secondary windings, N PWM signals staggered in phase from one another and transmit them to control terminals of power switches, enabling staggered control of N power switches. This multi-phase control provided by the isolated control module in the isolated SMPS allows for optimized EMI shielding performance, a balanced thermal distribution, less output ripple, smaller required output capacitance and significantly improved cost effectiveness of isolated SMPS.

### CROSS-REFERENCES TO RELATED APPLICATION

This application claims the priority of Chinese patent application number 202323092246.X, filed on Nov. 15, 2023, the entire contents of which are incorporated herein by reference.

### TECHNICAL FIELD

The present invention relates to the field of electronic circuits, and in particular to an isolated switched-mode power supply (SMPS) and an SMPS system.

### BACKGROUND

Isolated switched-mode power supply (SMPS) converters, also known as switching-mode power supplies or switch-mode power supplies, are a type of power supplies that convert electrical power at a high frequency. An isolated SMPS converter is connected typically to AC power (e.g., mains power) at its input and typically to a device requiring DC power, such as a mobile phone, laptop, etc., at its output to provide AC-to-DC voltage and current conversion between the two.

Isolated SMPSs used in chargers and adapters are typically of the flyback type. At present, in order to improve user experience, chargers and adapters are increasingly desired to provide higher output power. For a flyback SMPS, increased output power usually means required use of more powerful transformers, a higher switching frequency, power switches with lower on-resistance and larger capacitors, and sometimes even required continuous conduction mode (CCM) operation, which, however, tend to result in degraded electromagnetic interference (EMI) shielding capability, increased system size and higher cost of the power supply circuitry.

### SUMMARY

In view of this, the present invention provides an isolated SMPS and an SMPS system, which overcome the above-described problems associated with increased SMPS output power, including degraded EMI shielding capability, increased system size and higher cost.

In one possible implementation, the present invention provides an SMPS including N primary side circuits, N secondary side circuits, an isolated control module and N transformers, each of the primary side circuits including a power switch, each of the secondary side circuits including a synchronous rectifier, each of the transformers including a primary winding connected in series with the power switch in a respective one of the primary side circuits between an input terminal of the isolated SMPS and a primary side reference ground, each of the transformers including a secondary winding connected in series with the synchronous rectifier in a respective one of the secondary side circuits between an output terminal of the isolated SMPS and a secondary side reference ground, where N is an integer greater than or equal to 2. The isolated control module includes a primary side control module, an optocoupler and a secondary side control module, the primary side control module connected to control terminals of the power switches, the secondary side control module connected to control terminals of the synchronous rectifiers, the optocoupler connected between the secondary side control module and the primary side control module. The secondary side control module turns on or off the synchronous rectifiers based on respective N winding voltage signals from the secondary windings in the respective transformers. The secondary side control module generates optocoupler drive signals based on the output voltage signal from the isolated SMPS and the respective winding voltage signals, and the optocoupler receives the optocoupler drive signals and outputs optocoupler signals to the primary side control module. The primary side control module generates, based on the optocoupler signals, N PWM signals staggered in phase from one another and transmits the N PWM signals to the control terminals of the respective power switches to enable staggered control of the N power switches.

In one possible implementation, a turn-on time of each power switch is later than a turn-off time of the respective synchronous rectifier that is connected to the same transformer as the specific power switch.

In one possible implementation, the primary side control module includes a current threshold and frequency control module and a first logic control module connected to the current threshold and frequency control module, the current threshold and frequency control module adapted to generate a current threshold and frequency signals based on the optocoupler signals, the first logic control module adapted to generate the N PWM signals based on the current threshold and the frequency signals.

In one possible implementation, the primary side control module includes a current threshold and frequency control module and N parallel-connected second logic control modules, the current threshold and frequency control module adapted to generate a current threshold and frequency signals based on the optocoupler signals, a first one of the second logic control modules adapted to generate a first one of the PWM signals and (N−1) flag signals based on the current threshold and the frequency signals, the remaining (N−1) ones of the second logic control modules adapted to generate the respective remaining ones of the PWM signals based on the respective flag signals.

In one possible implementation, the primary side control module includes a current threshold and frequency control module and N series-connected second logic control modules, the current threshold and frequency control module adapted to generate a current threshold and frequency signals based on the optocoupler signals, a first one of the second logic control modules adapted to generate a first one of the PWM signals and a first flag signal based on the current threshold and the frequency signals, a second one of the second logic control modules adapted to generate a second one of the PWM signals and a second flag signal based on the first flag signal, an i-th one of the second logic control modules adapted to generate an i-th one of the PWM signals and an i-th flag signal based on an (i−1)-th flag signal, an N-th one of the second logic control modules adapted to generate an N-th one of the PWM signals based on an (N−1)-th flag signal.

In one possible implementation, the frequency signals are adapted for phase staggering of the N PWM signals, wherein the current thresholds are adapted to be compared with currents through the respective N power switches, and when the current in any of the power switches reaches the current threshold, the power switch is turned off, and wherein the primary side control module is also adapted to sample the current in each of the power switches.

In one possible implementation, the secondary side control module includes a third logic control module and an optocoupler drive module, the third logic control module connected to an input terminal of the optocoupler drive module, the third logic control module adapted to output first control signals to the optocoupler drive module based on the output voltage signal and the N winding voltage signals, the optocoupler drive module adapted to convert the first control signals that it receives into optocoupler drive signals for driving the optocoupler.

In one possible implementation, the third logic control module is connected to all the synchronous rectifiers, wherein the third logic control module outputs, based on the N winding voltage signals, N second control signals each for turning on or off a respective one of the synchronous rectifiers.

In one possible implementation, the third logic control module is adapted to determine if any of the winding voltage signals reaches a first predetermined value and, if so, turn on the respective synchronous rectifier.

In one possible implementation, the isolated SMPS further includes a primary side capacitor and a secondary side capacitor. One end of the primary side capacitor is connected to the input terminal of the isolated SMPS, and the other end of the primary side capacitor is connected to a primary side reference ground. One end of the secondary side capacitor is connected to the output terminal of the isolated SMPS, and the other end of the secondary side capacitor is connected to a secondary side reference ground.

In one possible implementation, the present invention provides an SMPS system including the isolated SMPS as defined above; and a load connected to the output terminal of the isolated SMPS.

Embodiments of the present invention provide an isolated SMPS including N primary side circuits, N secondary side circuits, an isolated control module and N transformers, each of the primary side circuits including a power switch, each of the secondary side circuits including a synchronous rectifier, each of the transformers including a primary winding connected in series with the power switch in a respective one of the primary side circuits between an input terminal of the isolated SMPS and a primary side reference ground, each of the transformers including a secondary winding connected in series with the synchronous rectifier in a respective one of the secondary side circuits between an output terminal of the isolated SMPS and a secondary side reference ground, where N is an integer greater than or equal to 2. The isolated control module includes a primary side control module, an optocoupler and a secondary side control module, the primary side control module connected to control terminals of the power switches, the secondary side control module connected to control terminals of the synchronous rectifiers, the optocoupler connected between the secondary side control module and the primary side control module. The secondary side control module turns on or off the synchronous rectifiers based on respective N winding voltage signals from the secondary windings in the respective transformers. The secondary side control module generates optocoupler drive signals based on the output voltage signal from the isolated SMPS and the respective winding voltage signals, and the optocoupler receives the optocoupler drive signals and outputs optocoupler signals to the primary side control module. The primary side control module generates, based on the optocoupler signals, N PWM signals staggered in phase from one another and transmits the N PWM signals to the control terminals of the respective power switches to enable staggered control and operation of the N power switches. This multi-phase control allows for reduced size and cost of each single branch (e.g., each transformer), optimized EMI shielding performance, a balanced thermal distribution, less output ripple, smaller required output capacitance and improved cost effectiveness of the system.

Further features and aspects of the present invention will become apparent from the following detailed description of exemplary embodiments with reference to the attached drawings.

### BRIEF DESCRIPTION OF THE DRAWING

The accompanying drawings, which are incorporated in and constitute a part of the specification, illustrate exemplary embodiments, features and aspects of the present invention and, together with the description, serve to explain the principles of the invention.

FIG. 1 shows a schematic diagram of an SMPS according to an embodiment of the present invention.

FIG. 2 shows a schematic diagram of operating waveforms for the isolated SMPS according to an embodiment of the present invention.

FIG. 3 shows a schematic diagram of a secondary side control module according to an embodiment of the present invention.

FIG. 4 shows a schematic diagram of a primary side control module according to an embodiment of the present invention.

FIG. 5 shows a schematic diagram of another primary side control module according to an embodiment of the present invention.

FIG. 6 shows a schematic diagram of yet another primary side control module according to an embodiment of the present invention.

FIG. 7 shows a schematic diagram of another isolated SMPS according to an embodiment of the present invention.

FIG. 8 shows a schematic diagram of operating waveforms for the isolated SMPS of FIG. 7.

### DETAILED DESCRIPTION

Various exemplary embodiments, features and aspects of the present invention will be described in detail below with reference to the accompanying drawings. Elements of like function are represented with like reference numerals throughout the figures. While the various aspects of the embodiments are presented in the drawings, the drawings are not necessarily drawn to scale, unless specifically indicated.

The term “exemplary” is used herein to mean serving as an example, instance, or illustration. Any embodiment described herein as “exemplary” is not necessarily to be construed as preferred or advantageous over other embodiments. The terms “first,” “second,” “third” and the like (if present) in the description, claims and drawings of the invention are used for distinguishing between similar elements and not necessarily for describing a particular sequential or chronological order.

It is to be noted that, as used herein, unless expressly indicated or defined otherwise, the terms “interconnection”, “connection” and “coupling” and any variants thereof should be interpreted in a broad sense, for example, as being electrical or communicative, direct or via one or more intervening elements, or internal communication or interaction between two elements. Those of ordinary skill in the art can understand the specific meanings of the above-mentioned terms herein, depending on their context.

In order to facilitate description of the present invention, numerous specific details are set forth in the following particular embodiments. Those skilled in the art will understand that the invention may be practiced without some of the specific details. In some instances, methods, means, elements and circuits well known to those skilled in the art have not been described in particular detail in order to avoid unnecessarily obscuring the present disclosure.

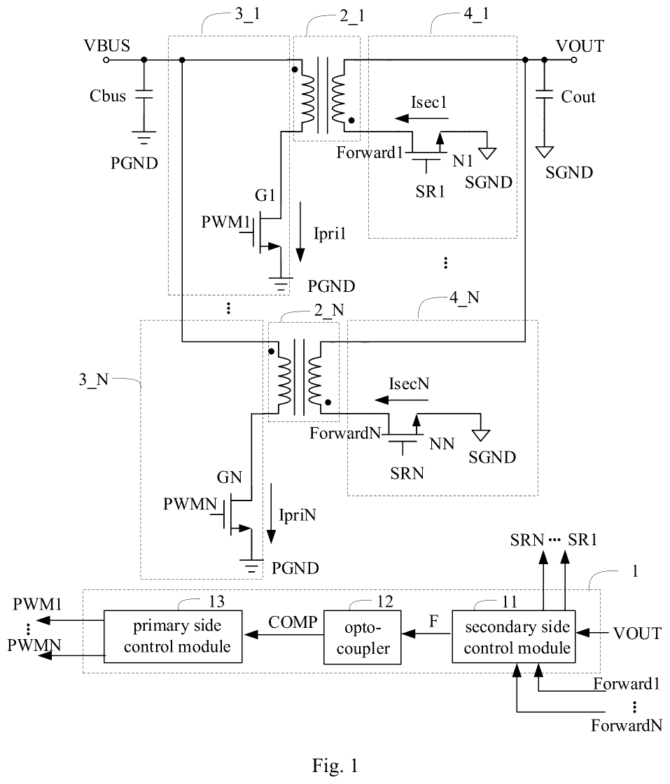

FIG. 1 shows a schematic diagram of an isolated switched-mode power supply (SMPS) according to an embodiment of the present invention. As shown in FIG. 1, the isolated SMPS includes N primary side circuit (e.g., 3_1-3_N), N secondary side circuits (e.g., 4_1-4_N), an isolated control module 1 and N transformers (e.g., 2_1-2_N), where N is an integer greater than or equal to 2. Each transformer may include primary and secondary windings coupled to each other. In each transformer, a ratio of the number of turns in the primary winding to the number of turns in the secondary winding may be Ns:1. The present invention are not limited to any particular number N of transformers, or to any particular value of the ratio Ns:1.

Each of the primary side circuits includes a power switch (e.g., G1-GN), and the primary winding in each of the transformers is connected in series with the power switch in a respective one of the primary side circuits between an input terminal of the isolated SMPS (at which a bus voltage VBUS is received, as shown in FIG. 1) and a primary side reference ground PGND. Each of the secondary side circuits includes a synchronous rectifier (e.g., N1-NN), and the secondary winding in each of the transformers is connected in series with the synchronous rectifier in a respective one of the secondary side circuits between an output terminal of the isolated SMPS (at which an output voltage signal VOUT is provided, as shown in FIG. 1) and a secondary side reference ground SGND.

For example, the primary side circuit 3_1 includes the power switch G1, and the primary winding in the transformer 2_1 is connected in series with the power switch G1 in the respective primary side circuit 3_1 between the input terminal of the isolated SMPS and the primary side reference ground PGND. The secondary side circuit 4_1 includes the synchronous rectifier N1, and the secondary winding in the transformer 2_1 is connected in series with the synchronous rectifier N1 in the respective secondary side circuit 4_1 between the output terminal of the isolated SMPS and the secondary side reference ground SGND. By analogy, the primary side circuit 3_N includes the power switch GN, and the primary winding in the transformer 2_N is connected in series with the power switch GN in the respective primary side circuit 4_N between the input terminal of the isolated SMPS and the primary side reference ground PGND. The secondary side circuit 4_N includes the synchronous rectifier NN, and the secondary winding in the transformer 2_N is connected in series with the synchronous rectifier NN in the respective secondary side circuit 4_N between the output terminal of the isolated SMPS and the secondary side reference ground SGND.

It is to be noted that the primary winding in the transformer 2_1 is connected in series between the power switch G1 in the respective primary side circuit 3_1 and the input terminal or between the power switch G1 in the respective primary side circuit 3_1 and primary side reference ground PGND of the isolated SMPS. The output terminal of the isolated SMPS is used to supply power to a load on the secondary side. It is to be noted that the secondary winding in the transformer 2_1 is connected in series between the synchronous rectifier in the respective secondary side circuit 4_1 and the output terminal or between the synchronous rectifier in the respective secondary side circuit 4_1 and secondary side reference ground SGND of the isolated SMPS.

The isolated control module 1 is connected to the power switches in the primary side circuits and to the synchronous rectifier switches in the secondary side circuits, and is adapted to generate N pulse-width modulated (PWM) signals (e.g., PWM1 to PWMN), which are staggered in phase from one another, based on the output voltage signal from the isolated SMPS and winding voltage signals from the respective secondary windings in the respective transformers. The isolated control module 1 transmits the generated N PWM signals PWM1-PWMN to respective control terminals of the respective power switches G1-GN to apply staggered control to the N power switches G1-GN for enabling staggered operation of the N power switches G1-GN. The isolated control module 1 is also adapted to turn on or off the synchronous rectifiers N1-NN based on the respective winding voltage signals Forward1-ForwardN from the secondary windings in the transformers so that a turn-on time of each power switch is later than a turn-off time of the respective synchronous rectifier that is connected to the same transformer as the power switch. For example, a turn-on time of the power switch Gk is later than a turn-off time of the synchronous rectifier Nk, where k∈[1,N].

The isolated SMPS further includes a first sampling circuit and a second sampling circuit. The first sampling circuit is connected to the output terminal of the isolated SMPS and the isolated control module 1, and is adapted to sample and process the output voltage signal VOUT from the isolated SMPS and provide the output voltage signal VOUT that has been processed to the isolated control module 1. The second sampling circuit is connected to the ends of the secondary windings that are connected to the synchronous rectifiers, as well as to the isolated control module 1, and is adapted to sample the winding voltage signals Forward1-ForwardN from the secondary windings and provide the winding voltage signals Forward1-ForwardN that have been processed to the isolated control module 1.

A primary current Iprik flows through the input terminal of the isolated SMPS toward the primary winding one of the transformers 2_k and the power switch Gk in the respective primary side circuit 3_k, and a secondary current Iseck flows through the synchronous rectifier Nk in the respective secondary side circuit 4_k and the secondary winding in the respective transformer 2_k toward the output terminal of the isolated SMPS, where k∈[1,N]. As shown in FIG. 1, the primary current Ipri1 flows through the input terminal of the isolated SMPS toward the primary winding in the transformer 2_1 and the power switch G1 in the primary side circuit 3_1, and the secondary current Isec1 flows through the synchronous rectifier N1 in the secondary side circuit 4_1 and the secondary winding in the transformer 2_1 toward the output terminal of the isolated SMPS; . . . ; the primary current IpriN flows through the input terminal of the isolated SMPS toward the primary winding in the transformer 2_N and the power switch GN in the primary side circuit 3_N, and the secondary current IsecN flows through the synchronous rectifier NN in the secondary side circuit 4_N and the secondary winding in the transformer 2_N toward the output terminal of the isolated SMPS.

In one possible implementation, as shown in FIG. 1, the isolated control module 1 includes a primary side control module 13, an optocoupler 12 and a secondary side control module 11. The secondary side control module 11 is connected to control terminals SR1-SRN of the synchronous rectifiers N1-NN, and the primary side control module 13 is connected to the control terminals PWM1-PWMN of the power switches G1-GN. The optocoupler 12 is connected between the secondary side control module 11 and the primary side control module 13.

The secondary side control module 11 turns on or off the synchronous rectifiers N1-NN based on the respective N winding voltage signals Forward1-ForwardN. Specifically, the secondary side control module 11 generates optocoupler drive signals F based on the output voltage signal VOUT from the isolated SMPS and the respective winding voltage signals Forward1-ForwardN from the secondary windings in the transformers. In particular, it generates an optocoupler drive signal F when the output voltage signal VOUT drops below a voltage threshold and the respective synchronous rectifier N1-NN is off. The optocoupler 12 receives the optocoupler drive signals F and outputs optocoupler signals COMP to the primary side control module 13, which then generates the respective N PWM signals PWM1-PWMN based on the optocoupler signals COMP and transmits the PWM signals PWM1-PWMN to the control terminal SR1-SRN of the respective power switches G1-GN. In this way, staggered control is applied to the N power switches G1-GN, enabling staggered operation of the N power switches G1-GN. The N PWM signals PWM1-PWMN are staggered in phase from one another.

The secondary side control module 11 and the primary side control module 13 may be each implemented as a hardware circuit constructed from general analog components, digital components, etc. The present invention is not limited to any particular such implementation.

Therefore, the isolated control module 1 not only electrically isolates the primary side circuits from the secondary side circuits for the N transformers, but also generates the N PWM signals PWM1-PWMN based on the output voltage signal VOUT and the winding voltage signals Forward1-ForwardN and transmit the N PWM signals PWM1-PWMN to the respective control terminals of the respective power switches G1-GN to turn on the N power switches G1-GN at staggered times. This multi-phase control allows for reduced size and cost of each single branch (e.g., each transformer), optimized EMI shielding performance, a balanced thermal distribution, less output ripple, smaller required output capacitance and improved cost effectiveness of the system.

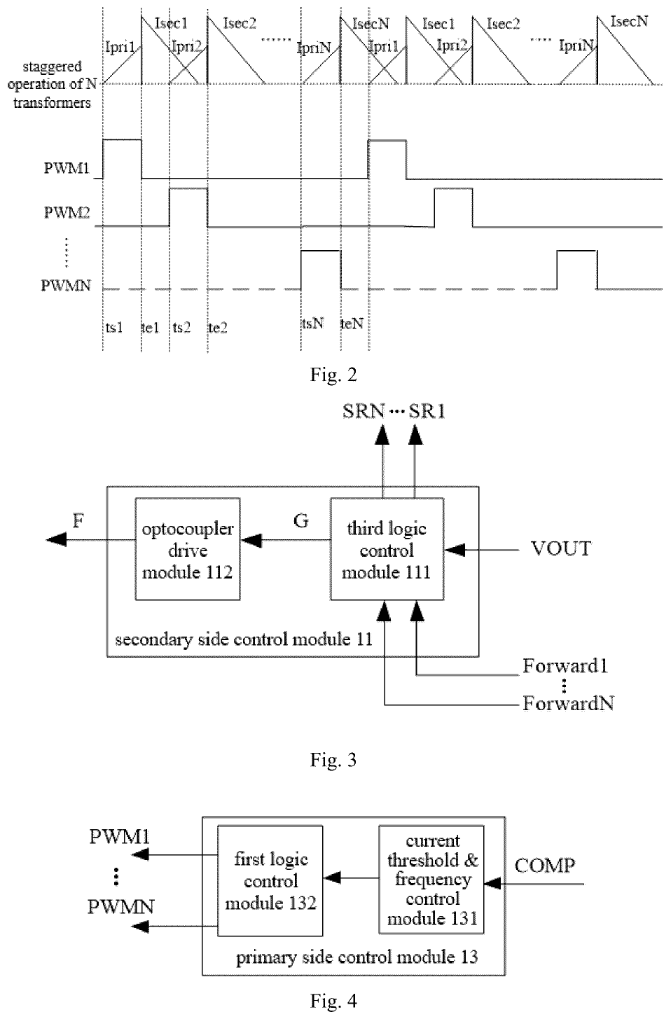

FIG. 2 shows a schematic diagram of operating waveforms for the isolated SMPS according to an embodiment of the present invention. As shown in FIG. 2, for any of the PWM signals PWMk output from the isolated control module 1 (k∈[1,N]), when it transitions from a low level to a high level (a rising edge) (at time ts1-N in FIG. 2), the power switch Gk is turned on, and the primary current Iprik gradually increases from zero. As the primary current Iprik flows through the primary winding in the transformer 2_k, the transformer 2_k stores energy in the form of a magnetic field. Due to a phase difference from the primary current Iprik, the secondary current Iseck through the secondary winding in the transformer 2_k remains zero as the primary current Iprik is flowing through the primary winding in the transformer 2_k.

When the PWM signal PWMk transitions from the high level back to the low level (a falling edge) (at time te1-N in FIG. 2), the power switch Gk is turned off, and the primary current Iprik drops to zero, reversing the polarity of the voltage across the primary winding in the transformer 2_k. As a result, energy is released from the transformer 2_k to provide the load on the secondary side with a voltage/current. At the same time, the secondary current Iseck through the transformer 2_k gradually decreases. When the release of energy from the transformer 2_k is complete, the secondary current Iseck through the secondary winding in the transformer 2_k drops to zero.

As shown in FIG. 2, the N PWM signals PWM1-PWMN generated by the isolated control module 1 may be staggered in phase from one another. For example, when the PWM signal PWM1 is high, all the remaining (N−1) PWM signals PWM2-N are low; when the PWM signal PWM2 is high, all the remaining (N−1) PWM signals PWM1 and PWM3-N are low; . . . ; and when the PWM signal PWMN is high, all the remaining (N−1) PWM signals PWM2-(N−1) are low.

The isolated control module 1 transmits the N PWM signals PWM1-PWMN that it generates to the respective control terminals of the respective power switches G1-GN. Since the N PWM signals PWM1-PWMN generated by the isolated control module 1 are staggered from one another in phase, the N power switches G1-GN are turned on or off alternately under the control of them (e.g., in interval ts1-te1, the power switch G1 is on and all the remaining power switches G2-N are off; in interval ts2-te2, the power switch G2 is on and all the remaining power switches G1 and G3-N are off; . . . ; and in interval tsN-teN, the power switch GN is on and all the remaining power switches G1-(N−1) are off), achieving multi-phase control of the isolated SMPS. In each cycle, the transformers 2_1-2_N may release the secondary currents Isec1-N in succession.

In order to provide higher output power, conventional isolated SMPSs are typically required to employ more powerful transformers, a higher switching frequency, power switches with lower on-resistance and larger capacitors, and sometimes even to operate in a continuous conduction mode (CCM).

In contrast, isolated SMPSs according to embodiments of the present invention may include N primary side circuits (each of which may include a power switch), N secondary side circuits, an isolated control module 1 and N parallel-connected transformers. The isolated control module 1 generates, based on an output voltage signal of the isolated SMPS and the respective winding voltage signals, N PWM signals PWM1-PWMN, which are staggered in phase from one another. The N PWM signals PWM1-PWMN are transmitted to respective control terminals of the respective power switches, enabling staggered control of the N power switches. This multi-phase control allows for reduced size and cost of each single branch (e.g., each transformer), optimized EMI shielding performance, a balanced thermal distribution, less output ripple, smaller required output capacitance and improved cost effectiveness of the system.

In one possible implementation, as shown in FIG. 1, the isolated SMPS is adapted to convert a bus voltage VBUS into an output voltage and further includes a primary side capacitor Cbus and a secondary side capacitor Cout. One end of the primary side capacitor Cbus is connected to an input terminal of the isolated SMPS and is adapted to receive the bus voltage VBUS. The other end of the primary side capacitor Cbus is connected to a primary side reference ground PGND. One end of the secondary side capacitor Cout is connected to an output terminal of the isolated SMPS, and the other end of the secondary side capacitor Cout is connected to a secondary side reference ground SGND. The primary and secondary sides of the transformers are not commonly grounded.

In an example, the bus voltage VBUS may contain some high-frequency noise, which may interfere with other elements in the primary side circuits and make operation of the primary side circuits unstable. The primary side capacitor Cbus can filter the bus voltage VBUS and store energy therefrom, ensuring stability of the primary side circuits. Likewise, the output voltage may also contain some high-frequency noise, which may interfere with other elements in the secondary side circuits and make operation of the secondary side circuits unstable. The secondary side capacitor Cout can filter the output voltage and store energy therefrom, ensuring stability of the secondary side circuits.

In addition, in addition to filtering out interfering noise, the secondary side capacitor Cout can also enable the provision of a stable output voltage. The output voltage of the isolated SMPS can be affected by current variations in load circuitry. Without support from the secondary side capacitor Cout, the output voltage may significantly fluctuate in these cases, affecting normal operation of the load circuitry. The secondary side capacitor Cout can smooth the output voltage by reducing fluctuations therein, ensuring stability of the load circuitry. For example, in response to a transient load current surge, the secondary side capacitor Cout may release electrical energy that it stores to provide the required transient high power.

Therefore, the primary side capacitor Cbus and the secondary side capacitor Cout in the isolated SMPS can filter out high-frequency noise, stabilize the power supply voltage and provide additional power storage capacity, thereby improving the stability and reliability of the isolated SMPS.

Continuing the example of FIG. 1, the secondary side control module 11, the optocoupler 12 and the primary side control module 13 in the isolated control module 1 are further exemplified below.

For example, a first input terminal of the secondary side control module 11 is connected to the output terminal of the isolated SMPS in order to receive the output voltage signal VOUT. The secondary side control module 11 is connected to the N secondary windings in order to receive the N winding voltage signals Forward1-ForwardN. Moreover, it outputs optocoupler drive signals F to the optocoupler 12, based on the output voltage signal VOUT and the winding voltage signals Forward1-ForwardN. The secondary side control module 11 includes a first sampling circuit and a second sampling circuit. The first sampling circuit is connected to the output terminal of the isolated SMPS in order to receive the output voltage signal VOUT, and the second sampling circuit is connected to the N secondary windings in order to receive the N winding voltage signals Forward1-ForwardN. The winding voltage signals are voltages from nodes where the secondary windings are connected to the synchronous rectifiers.

The secondary side control module 11 is connected to the nodes where the N secondary windings are connected to the synchronous rectifiers and to control terminals SR1-SRN of the N synchronous rectifiers N1-NN. The secondary side control module 11 is also adapted to turn on or off the synchronous rectifiers based on the respective winding voltage signals Forward1-ForwardN.

As shown in FIG. 1, the isolated SMPS includes N synchronous rectifiers (e.g., N1-NN) corresponding to the respective N transformers (e.g., 2_1-2_N). The secondary winding in each transformer is connected to a respective one of the synchronous rectifiers at a different node. For example, a first terminal of the secondary winding in the transformer 2_1 (represented by a dot (“•”) in FIG. 1) is connected to a first terminal of the synchronous rectifier N1 at a node and a second terminal of the synchronous rectifier N1 is connected to the secondary side reference ground SGND; . . . ; and a first terminal of the secondary winding in the transformer 2_N (represented by a dot (“·”) in FIG. 1) is connected to a first terminal of the synchronous rectifier NN at a node and a second terminal of the synchronous rectifier NN is connected to the secondary side reference ground SGND.

Since the first terminal of the secondary winding in the transformer 2_1 (represented by a dot (“·”) in FIG. 1) is connected to the first terminal of the synchronous rectifier N1 at a node, the secondary side control module 11 can output, based on the sampled winding voltage signal Forward1, a control signal to the control terminal SR1 of the synchronous rectifier N1 to turn on or off the synchronous rectifier N1.

Similarly, since the first terminal of the secondary winding in the transformer 2_2 (represented by a dot (“·”) in FIG. 1) is connected to the first terminal of the synchronous rectifier N2 at a node, the secondary side control module 11 can output, based on the sampled winding voltage signal Forward2, a control signal to the control terminal SR2 of the synchronous rectifier N2 to turn on or off the synchronous rectifier N2.

By analogy, since the first terminal of the secondary winding in the transformer 2_N (represented by a dot (“·”) in FIG. 1) is connected to the first terminal of the synchronous rectifier NN at a node, the secondary side control module 11 can output, based on the sampled winding voltage signal ForwardN, a control signal to the control terminal SRN of the synchronous rectifier NN to turn on or off the synchronous rectifier NN.

FIG. 3 shows a schematic diagram of a secondary side control module 11 according to an embodiment of the present invention. Referring to FIGS. 1 and 3, the secondary side control module 11 includes a third logic control module 111 and an optocoupler drive module 112. A first output terminal of the third logic control module 111 is connected to an input terminal of the optocoupler drive module 112. The third logic control module 111 outputs, based on the output voltage signal VOUT and the N winding voltage signals Forward1-ForwardN, first control signal G to the optocoupler drive module 112. The optocoupler drive module 112 receives the first control signal G and converts it into the optocoupler drive signal F for driving the optocoupler 12.

With this arrangement, the third logic control module 111 can determine, based on the output voltage signal VOUT from the isolated SMPS and the N winding voltage signals Forward1-ForwardN, the first control signal G to be fed back to the primary side circuits. The optocoupler drive module 112 can then enhance drive power of the first control signal G by converting it into the optocoupler drive signal F for driving the optocoupler 12. This facilitates communication and isolation between the primary and secondary sides of the transformers.

In one possible implementation, the third logic control module 111 is also adapted to turn on or off the respective synchronous rectifiers based on the N winding voltage signals Forward1-ForwardN. For example, the third logic control module 111 may be based on the winding voltage signal Forward1 to turn on or off the synchronous rectifier N1, on the winding voltage signal Forward2 to turn on or off the synchronous rectifier N2, . . . , and on the winding voltage signal ForwardN to turn on or off the synchronous rectifier NN.

In one possible implementation, the third logic control module 111 is adapted to determine if any of the N winding voltage signals Forward1-ForwardN reaches a first predetermined value (which may be negative). If so, the respective synchronous rectifier is turned on.

For example, the first terminal of the secondary winding in the transformer 2_1 (represented by a dot (“•”) in FIG. 1) may be connected to the first terminal of the synchronous rectifier N1 at a node, and the third logic control module 111 may be based on the winding voltage signal Forward1 received at the first terminal of the secondary winding in the transformer 2_1 to output a control signal to the control terminal SR1 of the synchronous rectifier N1. When the winding voltage signal Forward1 reaches the first predetermined value (e.g., a negative value), the control signal may be kept high, maintaining the synchronous rectifier N1 on. Accordingly, freewheeling of the secondary current Isec1 in the transformer 2_1 is initiated. Otherwise, when the winding voltage signal Forward1 reaches a second predetermined value, the third logic control module 111 may also be adapted to maintain the control signal low and thereby keep the synchronous rectifier N1 off.

Similarly, the first terminal of the secondary winding in the transformer 2_2 (represented by a dot (“·”) in FIG. 1) may be connected to the first terminal of the synchronous rectifier N2 at a node, and the third logic control module 111 may be based on the winding voltage signal Forward2 received at the first terminal of the secondary winding in the transformer 2_2 to output a control signal to the control terminal SR2 of the synchronous rectifier N2. When the winding voltage signal Forward2 reaches the first predetermined value (e.g., a negative value), the control signal may be kept high, maintaining the synchronous rectifier N2 on. Accordingly, freewheeling of the secondary current Isec2 in the transformer 2_2 is initiated. Otherwise, when the winding voltage signal Forward2 reaches the second predetermined value (at this time, the secondary current is zero), the third logic control module 111 may also be adapted to maintain the control signal low and thereby keep the synchronous rectifier N2 off.

By analogy, the first terminal of the secondary winding in the transformer 2_N (represented by a dot (“·”) in FIG. 1) may be connected to the first terminal of the synchronous rectifier NN at a node, and the third logic control module 111 may be based on the winding voltage signal ForwardN received at the first terminal of the secondary winding in the transformer 2_N to output a control signal to the control terminal SRN of the synchronous rectifier NN. When the winding voltage signal ForwardN reaches the first predetermined value (e.g., a negative value), the control signal may be kept high, maintaining the synchronous rectifier NN on. Accordingly, freewheeling of the secondary current IsecN in the transformer 2_N is initiated. Otherwise, when the winding voltage signal ForwardN reaches the second predetermined value, the third logic control module 111 may also be adapted to maintain the control signal low and thereby keep the synchronous rectifier NN off.

In this way, in each cycle, the third logic control module 111 samples winding voltages (e.g., Forward1-ForwardN) at the N nodes where the secondary windings in the N transformers (2_1-2_N) are connected in series with the respective N synchronous rectifiers (e.g., N1-NN) and is based thereon to determine control signals to be output to the control terminals of the respective N synchronous rectifiers (e.g., SR1-SRN) to alternately turn on the N synchronous rectifiers, thereby facilitating successive freewheeling of the secondary currents in the N transformers. As shown in FIG. 2, freewheeling may be initiated in sequence from Isec1 to IsecN.

In an example, the optocoupler 12 is connected between the secondary side control module 11 and the primary side control module 13 and serves to electrically isolate the primary side control module 13 from the secondary side control module 11, convert the optocoupler drive signal F received from the secondary side control module 11 into the optocoupler signal COMP and transmit the optocoupler signal COMP to the primary side control module 13.

The optocoupler 12 is able to transmit electrical energy from one circuit (e.g., the secondary side control module 11) to another (e.g., the primary side control module 13) through an optical transmission path while electrically isolating the two circuits from each other. The optocoupler 12 is able to couple an electrical signal from one circuit to another without any electrical contact between the two circuits.

The optocoupler 12 is also able to convert electrical energy into a light beam using a light-emitting diode and then guide the light beam to a light sensor (e.g., a photodiode, a phototransistor or the like), which then converts optical energy back into electrical energy.

With the optocoupler 12 isolating the primary side control module 13 and the secondary side control module 11 from each other, the primary side circuits can be better isolated from the secondary side circuits for the transformers, reducing voltage spikes, as well as noise and interference associated with communicative connections.

In an example, the primary side control module 13 has N output terminals each connected to the control terminal of a different one of the power switches to enable transmission of the N PWM signals PWM1-PWMN generated by the primary side control module 13 to the control terminals in the respective N power switches for alternately turning on the N power switches. Thus, multi-phase control of the isolated SMPS can be achieved. In addition, the isolated SMPS includes N power switches corresponding to the respective N transformers, and the primary winding in each transformer 2 is connected in series with a respective one of the power switches.

As shown in FIG. 1, a first terminal of the primary winding in the transformer 2_1 (represented by a dot (“·”) in FIG. 1) is connected to the input terminal of the isolated SMPS in order to receive the bus voltage VBUS, and a second terminal of the primary winding in the transformer 2_1 is connected to a first terminal of the power switch G1. A second terminal of the power switch G1 is connected to the primary side reference ground PGND, and the control terminal of the power switch G1 is connected to the output terminal of the isolated control module 1 in order to receive the first PWM signal PWM1 generated by the isolated control module 1.

Similarly, a first terminal of the primary winding in the transformer 2_2 is also connected to the input terminal of the isolated SMPS in order to receive the bus voltage VBUS, and a second terminal of the primary winding in the transformer 2_2 is connected to a first terminal of the power switch G2. A second terminal of the power switch G2 is connected to the primary side reference ground PGND, and the control terminal of the power switch G2 is connected to the output terminal of the isolated control module 1 in order to receive the second PWM signal PWM2 generated by the isolated control module 1.

By analogy, a first terminal of the primary winding in the transformer 2_N is connected to the input terminal of the isolated SMPS in order to receive the bus voltage VBUS, and a second terminal of the primary winding in the transformer 2_N is connected to a first terminal of the power switch GN. A second terminal of the power switch GN is connected to the primary side reference ground PGND, and the control terminal of the power switch GN is connected to the output terminal of the isolated control module 1 in order to receive the N-th PWM signal PWMN generated by the isolated control module 1.

In this way, the primary side control module 13 can generate the N PWM signals PWM1-PWMN based on the optocoupler signal COMP and transmit it to the power switches G1-GN, thereby alternately turning on or off the power switches G1-GN to stagger their operation.

FIG. 4 shows a schematic diagram of a primary side control module 13 according to an embodiment of the present invention. As shown in FIG. 4, the primary side control module 13 includes a current threshold and frequency control module 131 and a first logic control module 132 connected to the current threshold and frequency control module 131. The current threshold and frequency control module 131 is adapted to generate a current threshold and frequency signals based on the optocoupler signal COMP, and the first logic control module 132 is adapted to generate the N PWM signals PWM1-PWMN, which are staggered in phase from one another, based on the current threshold and frequency signals.

The frequency signals are turn-on trigger signals generated based on the optocoupler signal COMP, and the current threshold is compared with currents through the N power switches. When the current in any of the power switches reaches the current threshold, the power switch is turned off. The primary side control module 13 samples the currents in the power switches, for example, by means of sampling resistors connected to the respective power switches.

As shown in FIG. 2, a corresponding one of the frequency signals may be a clock signal for turning on the power switch G1 at ts1, causing the primary current Ipri1 to ramp up. The primary side control module 13 may sample the primary current Ipri1 through the power switch G1 using a sampling resistor connected in series with the power switch G1 (e.g., between the second terminal of the power switch G1 and the primary side reference ground PGND, although not shown in FIG. 1). The current threshold is compared with the primary current Ipri1 through the power switch G1, and when the primary current Ipri1 reaches the current threshold (at te1 in FIG. 2), the power switch G1 is turned off.

Likewise, a corresponding one of the frequency signals may be used to turn on the power switch G2 at ts2, causing the primary current Ipri2 to ramp up. The primary side control module 13 may sample the primary current Ipri2 through the power switch G2 using a sampling resistor connected in series with the power switch G2 (e.g., between the second terminal of the power switch G2 and the primary side reference ground PGND, although not shown in FIG. 1). The current threshold is compared with the primary current Ipri2 through the power switch G2, and when the primary current Ipri2 reaches the current threshold (at te2 in FIG. 2), the power switch G2 is turned off.

By analogy, a corresponding one the frequency signals may be used to turn on the power switch GN at tsN, causing the primary current IpriN to ramp up. The primary side control module 13 may sample the primary current IpriN through the power switch GN using a sampling resistor connected in series with the power switch GN (e.g., between the second terminal of the power switch GN and the primary side reference ground PGND, although not shown in FIG. 1). The current threshold is compared with the primary current IpriN through the power switch GN, and when the primary current IpriN reaches the current threshold (at teN in FIG. 2), the power switch GN is turned off.

In this way, the frequency signals enable phase staggering of the N PWM signals PWM1-PWMN, and the current threshold is compared with the currents through the power switches G1-GN so that any of the power switches G1-GN is turned off when the current therethrough reaches the threshold. It is to be noted that the current threshold is not constant but varies with the output voltage signal VOUT.

Accordingly, the current threshold and frequency control module 131 is able to determine the current threshold and the frequency signals, based on the optocoupler signal COMP determined by the output voltage signal VOUT. In response to a decrease in the output voltage signal VOUT, the optocoupler signal COMP may be increased. At the same time, the frequency signals and the current threshold may be both increased. Alternatively, one of the frequency signals and the current threshold may be maintained, with the other being increased. In response to an increase in the output voltage signal VOUT, the optocoupler signal COMP may be decreased. Meanwhile, the frequency signals and the current threshold may be both decreased. Alternatively, one of the frequency signals and the current threshold may be maintained, with the other being decreased.

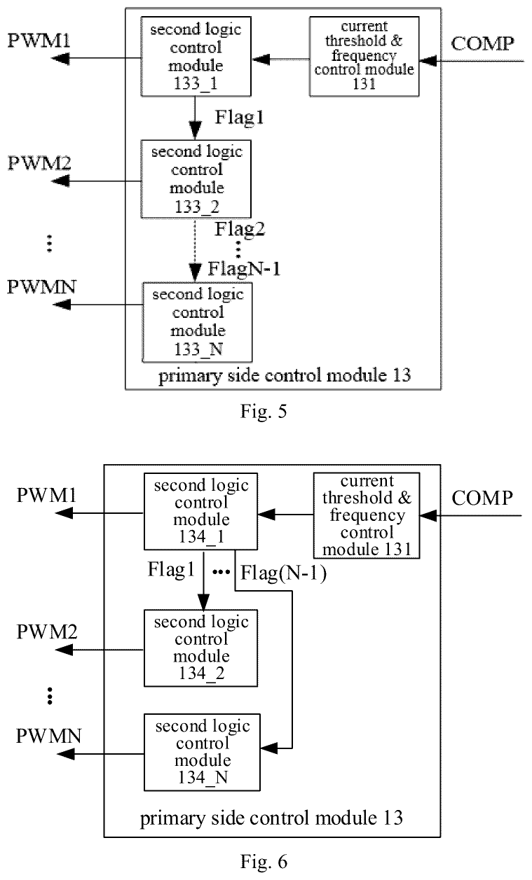

FIG. 5 shows a schematic diagram of another primary side control module 13 according to an embodiment of the present invention. As shown in FIG. 5, the primary side control module 13 includes a current threshold and frequency control module 131 and N series-connected second logic control modules. The current threshold and frequency control module 131 is adapted to generate a current threshold and frequency signals based on the optocoupler signal COMP. A first one of the second logic control modules is adapted to generate the first PWM signal PWM1 and a first flag signal Flag1 based on the current threshold and frequency signals. A second one of the second logic control modules is adapted to generate the second PWM signal PWM2 and a second flag signal Flag2 based on the first flag signal Flag1. An i-th one of the second logic control modules is adapted to generate the i-th PWM signal PWMi and an i-th flag signal Flagi based on an (i−1)-th flag signal Flag (i−1). An N-th one of the second logic control modules is adapted to generate the N-th PWM signal PWMN based on an (N−1)-th flag signal Flag (N−1). The current threshold and frequency control module 131 functions in the same way as is described above, and further description thereof is deemed unnecessary.

Compared with the first PWM signal PWM1, each of the other PWM signals PWM2-N may have the same waveform and a different phase. The first second logic control module is based on the current threshold and frequency signals to generate both the first PWM signal PWM1 and the first flag signal Flag1, which indicates a phase difference between the first and the adjacent, second PWM signals. The second second logic control module is based on the first flag signal Flag1 to generate the second PWM signal PWM2, and transmits the second flag signal Flag2 that is determined by the first flag signal Flag1 to the adjacent, third second logic control module. By analogy, the N-th second logic control module is based on the (N−1)-th flag signal Flag (N−1) received from the (N−1)-th second logic control module to generate the N-th PWM signal PWMN.

As shown in FIG. 5, the primary side control module 13 includes a current threshold and frequency control module 131 and N second logic control modules, e.g., 133_1-3_N. The current threshold and frequency control module 131 and the second logic control modules are connected in series one to another. The current threshold and frequency control module 131 is adapted to generate a current threshold and frequency signals based on the optocoupler signal COMP. A first one of the second logic control module 133_1 is adapted to generate a first PWM signal PWM1 and a flag signal Flag1, based on the current threshold and frequency signals, and each of the remaining second logic control modules 133_i (i∈[2,N]) is adapted to generate a corresponding PWM signal PWMi based on a flag signal Flag1-(i−1) generated by the immediately previous second logic control module 133_(i−1) that it is connected in series to.

The current threshold and frequency control module 131 is the same as that described above in connection with FIG. 4 and, therefore, needs not be described in further detail herein.

In one example, the N PWM signals PWM1-PWMN have the same waveform but differ in phase. Each of the flag signals indicates a phase difference between a corresponding adjacent pair of PWM signals. That is, the PWM signal PWMi generated by the second logic control module 133_i lags behind the PWM signal PWM (i−1) generated by the second logic control module 133_(i−1) by a phase difference indicated by the corresponding flag signal.

In one possible implementation, the primary side control module 13 includes a current threshold and frequency control module 131 and N parallel-connected second logic control modules. The current threshold and frequency control module 131 is adapted to generate a current threshold and frequency signals based on the optocoupler signals. A first one of the second logic control module is adapted to generate the first PWM signal and (N−1) flag signals based on the current threshold and the frequency signals, and the remaining (N−1) second logic control modules are adapted to generate the respective (N−1) PWM signals based on the respective flag signals. The current threshold and frequency control module 131 functions in the same way as is described above, and further description thereof is deemed unnecessary.

Compared with the first PWM signal PWM1, each of the other PWM signals PWM2-N may have the same waveform and a different phase. The first second logic control module is based on the current threshold and the frequency signals to generate the first PWM signal PWM1 and the (N−1) flag signals, which indicate phase differences of the respective PWM signals PWM2-N from the first PWM signal PWM1. The other (N−1) second logic control modules generate the respective PWM signals based on the respective flag signals.

FIG. 6 shows a schematic diagram of yet another primary side control module 13 according to an embodiment of the present invention. As shown in FIG. 6, the primary side control module 13 includes a current threshold and frequency control module 131 and N second logic control modules, e.g., 134_1-4_N. The current threshold and frequency control module 131 is connected to a first one of the second logic control module 134_1, which is in turn connected to each of the remaining second logic control modules 134_2-N.

The current threshold and frequency control module 131 is adapted to generate a current threshold and frequency signals based on the optocoupler signal COMP. The first second logic control module 134_1 is adapted to generate the first PWM signal PWM1 and flag signals Flag1-(N−1) based on the current threshold and the frequency signals. Each of the remaining second logic control modules 134_i (i∈[2, N]) is adapted to generate the respective PWM signal PWMi based on a respective one of the flag signals Flag1-(N−1), where Flagi=i×Flag1, and i∈[1,N−1].

The current threshold and frequency control module 131 is the same as that described above in connection with FIG. 4 and, therefore, needs not be described in further detail herein.

In one example, the N PWM signals PWM1-PWMN have the same waveform but differ in phase. Each of the flag signals Flagi indicates a phase difference between the respective PWM signal PWMi and the first PWM signal PWM1. That is, the PWM signal PWMi generated by the second logic control module 133_i lags behind the PWM signal PWM1 generated by the second logic control module 134_1 by a phase difference indicated by the flag signal Flag (i−1).

In this way, the N PWM signals PWM1-PWMN can be generated by the current threshold and frequency control module 131 and the N second logic control modules and transmitted to the power switches G1-GN, which alternately drive the power switches G1-GN and thereby stagger their operation. In practical applications, any suitable number of second logic control modules may be used, and they may be arranged and wired in any suitable manner. This makes the circuit more flexible and applicable to a wider range of applications.

In an illustrative example, the isolated SMPS includes two transformers, and the power switches and synchronous rectifiers are implemented as p-channel MOSFET devices. The MOSFET devices serve as switches in the circuit, and may be of either or both of the NPN and PNP types, without limiting the present invention.

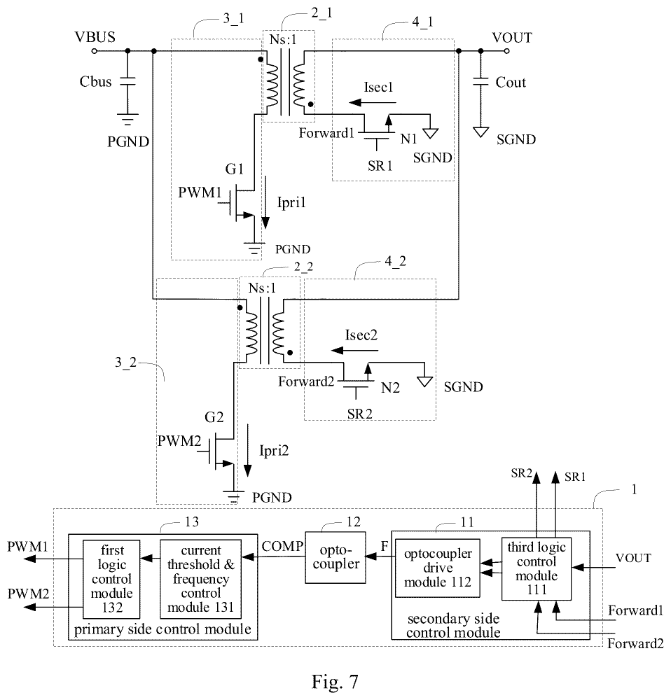

FIG. 7 shows a schematic diagram of an isolated SMPS according to an embodiment of the present invention. As shown in FIG. 7, the isolated SMPS may include two (N=2) primary side circuits 3_1 and 3_2, two secondary side circuits 4_1 and 4_2, an isolated control module 1 and two transformers 2_1 and 2_2. The primary side circuit 3_1 includes a power switch G1, and the primary side circuit 3_2 includes a power switch G2. The secondary side circuit 4_1 includes a synchronous rectifier N1, and the secondary side circuit 4_2 includes a synchronous rectifier N2.

A first terminal (represented by a dot (“·”) in FIG. 7) of a primary winding in the transformer 2_1 is connected to an input terminal of the isolated SMPS in order to receive a bus voltage VBUS, and a second terminal of the primary winding in the transformer 2_1 is connected to a drain of the power switch G1, and a source of the power switch G1 is connected to a primary side reference ground PGND. A gate (control terminal) of the power switch G1 is connected to a first logic control module 132 in a primary side control module 13 in order to receive a PWM signal PWM1.

A second terminal of a secondary winding in the transformer 2_1 is connected to an output terminal of the isolated SMPS in order to provide an output voltage signal VOUT, and a first terminal (represented by a dot (“·”) in FIG. 7) of the secondary winding in the transformer 2_1 is connected to a drain of the synchronous rectifier N1 at a node. A source of the synchronous rectifier N1 is connected to a secondary side reference ground SGND. The node is connected to a third logic control module 111 in a secondary side control module 11 to allow a winding voltage signal Forward1 at the node to be transmitted to the third logic control module 111. A gate SR1 (control terminal) of the synchronous rectifier N1 is connected to the third logic control module 111 in order to receive a control signal, which is determined by the third logic control module 111 based on the winding voltage signal Forward1 that it receives.

Similarly, a first terminal (represented by a dot (“·”) in FIG. 7) of a primary winding in the transformer 2_2 is also connected to the input terminal of the isolated SMPS in order to receive the bus voltage VBUS, and a second terminal of the primary winding in the transformer 2_2 is connected to a drain of the power switch G2, and a source of the power switch G2 is connected to the primary side reference ground PGND. A gate of the power switch G2 is connected to the first logic control module 132 in the primary side control module 13 in order to receive a PWM signal PWM2.

A second terminal of a secondary winding in the transformer 2_2 is also connected to the output terminal of the isolated SMPS in order to provide the output voltage signal VOUT, and a first terminal (represented by a dot (“·”) in FIG. 7) of the secondary winding in the transformer 2_2 is connected to a drain of the synchronous rectifier N2 at a node. A source of the synchronous rectifier N2 is connected to the secondary side reference ground SGND. The node is also connected to the third logic control module 111 in the secondary side control module 11 to allow a winding voltage signal Forward2 at the node to be transmitted to the third logic control module 111. A gate SR2 (control terminal) of the synchronous rectifier N2 is connected to the third logic control module 111 in order to receive a control signal, which is determined by the third logic control module 111 based on the winding voltage signal Forward2 that it receives.

As shown in FIG. 7, the isolated control module 1 includes the secondary side control module 11, an optocoupler 12 and the primary side control module 13, which are connected in sequence. The third logic control module 111 in the secondary side control module 11 may sample the output voltage signal VOUT of the isolated SMPS and the N winding voltage signals and utilize an optocoupler drive module 112 to generate optocoupler drive signal F to the optocoupler 12. The optocoupler 12 may convert the optocoupler drive signal F into optocoupler signal COMP. In this way, isolated communication between the primary and secondary sides of the isolated SMPS is achieved. A current threshold and frequency control module 131 in the primary side control module 13 may then determine a current threshold and frequency signals based on the optocoupler signal COMP, and the first logic control module 132 in the primary side control module 13 may determine the PWM signals PWM1 and PWM2, which are staggered from each other in phase, based on the current threshold and the frequency signals. It is to be noted that although the primary side control module 13 has been shown in the FIG. 7 as being implemented in accordance with the embodiment of FIG. 4, the present disclosure is not so limited, because it may also be implemented in accordance with either of the embodiments of FIGS. 5 and 6.

As shown in FIG. 7, the isolated SMPS further includes a primary side capacitor Cbus and a secondary side capacitor Cout. One end of the primary side capacitor Cbus is connected to the input terminal of the isolated SMPS, and the other end of the primary side capacitor Cbus is connected to the primary side reference ground PGND. One end of the secondary side capacitor Cout is connected to the output terminal of the isolated SMPS, and the other end of the secondary side capacitor Cout is connected to the secondary side reference ground SGND.

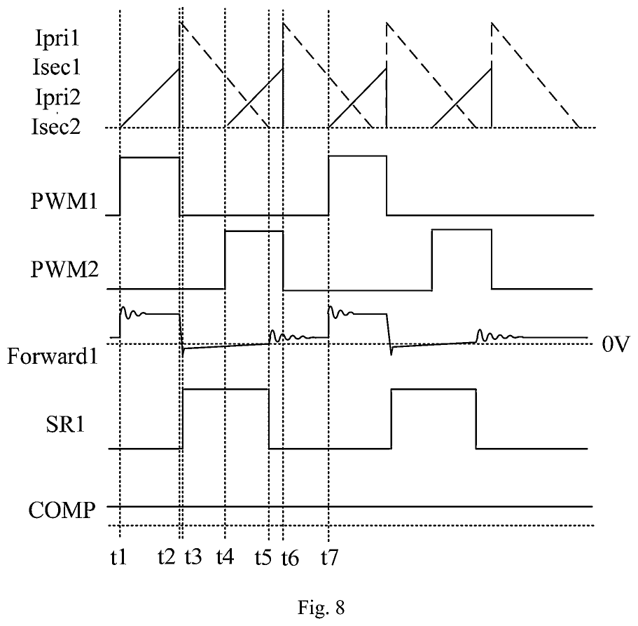

FIG. 8 shows a schematic diagram of operating waveforms for the isolated SMPS of FIG. 7. In FIG. 8, a primary current Ipri1 in the transformer 2_1 is represented by black solid lines, a primary current Ipri2 in the transformer 2_2 is represented by grey solid lines, a secondary current Isec1 in the transformer 2_1 is represented by black dashed lines, and a secondary current Isec2 in the transformer 2_2 is represented by grey dashed lines.

At time t1, the PWM signal PWM1 output from the primary side control module 13 transitions high, turning the power switch G1 on. Accordingly, the primary current Ipri1 in the transformer 2_1 gradually increases from zero, and the transformer 2_1 stores energy therefrom in the form of a magnetic field.

At time t2, the primary current Ipri1 in the transformer 2_1 reaches the current threshold, and the PWM signal PWM1 output from the primary side control module 13 responsively transitions from high to low, turning off the power switch G1. Consequently, the primary current Ipri1 in the transformer 2_1 drops to zero, and the transformer 2_1 starts releasing energy that it stores, initiating freewheeling of the secondary current Isec1 in the transformer 2_1. At the same time, the drain voltage Forward1 of the synchronous rectifier N1 connected to the secondary side of the transformer 2_1 starts to decrease sharply. At time t3, the secondary side control module 11 detects that the drain voltage Forward lof the synchronous rectifier N1 reaches a first predetermined value and responsively pulls a control signal that it outputs (e.g., to the control terminal SR1 of the synchronous rectifier N1) from low to high, turning on the synchronous rectifier N1. As a result, the secondary current Isec1 in the transformer 2_1 gradually decreases and becomes zero at t5. When the secondary side control module 11 detects that the winding voltage signal Forward1 reaches a second predetermined value, it pulls the control signal that it outputs from high to low, turning off the synchronous rectifier N1.

Likewise, at time t4, the PWM signal PWM2 output from the primary side control module 13 transitions high, turning the power switch G2 on. At time t6, the primary current Ipri2 in the transformer 2_2 reaches the current threshold, and the PWM signal PWM2 output from the primary side control module 13 responsively transitions from high to low, turning off the power switch G2. Accordingly, freewheeling of the secondary current Isec2 in the transformer 2_2 is initiated.

It will be appreciated that, although not shown in FIG. 8, the drain voltage Forward2 of the synchronous rectifier N2 (e.g., a winding voltage signal) and the control signal thereof (e.g., at the control terminal SR2 of the synchronous rectifier N2) may have similar waveforms to the drain voltage Forward1 of the synchronous rectifier N1 and the control signal thereof (e.g., at the control terminal SR1 of the synchronous rectifier N1) and, therefore, need not be described in further detail herein

The optocoupler signal COMP are generated as feedbacks of the output voltage signal VOUT from the isolated SMPS, and the primary side control module 13 generates the current threshold and the frequency signals based on the optocoupler signal COMP. Based on these, the phase-staggered PWM signals PWM1 and PWM2 are in turn generated to alternately drive the power switch G1 and the power switch G2 to alternately initiate freewheeling of the secondary current Isec1 in the transformer 2_1 and the secondary current Isec2 in the transformer 2_2. In this way, a more stable output voltage can be obtained.

Embodiments of the present invention also provide an SMPS system including an isolated SMPS as defined above and a load connected to the output terminal of the isolated SMPS, from which the output voltage signal VOUT is provided as a power supply to the load.

In order to provide higher output power, conventional isolated SMPSs are typically required to employ more powerful transformers, a higher switching frequency, power switches with lower on-resistance and larger capacitors, and sometimes even to operate in a continuous conduction mode (CCM).

In contrast, isolated SMPSs according to embodiments of the present invention may include an isolated control module 1 and N transformers. The isolated control module 1 generates N PWM signals PWM1-PWMN, which can alternately turn on the N power switches and thereby enable their staggered operation. This multi-phase control of the isolated SMPS allows for reduced size and cost of each single branch (e.g., each transformer circuit), optimized EMI shielding performance, a balanced thermal distribution, less output ripple, smaller required output capacitance and improved cost effectiveness of the system.

In the above, each embodiment is described with individual emphasis, and for details of any feature that is not detailed in a certain embodiment, reference can be made to the description of any other embodiment with such details. The foregoing description presents merely a few specific embodiments of the present invention, and the scope of the present application is in no way limited thereto. Any and all variations or substitutions that can be easily devised without departing from the scope of the disclosure herein by those of ordinary skill in the art are intended to fall within the scope of this application. Thus, the scope of the application is as defined by the appended claims.

What is claimed is:

1. An isolated switched-mode power supply (SMPS), comprising N primary side circuits, N secondary side circuits, an isolated control module and N transformers, each of the primary side circuits comprising a power switch, each of the secondary side circuits comprising a synchronous rectifier, each of the transformers comprising a primary winding connected in series with the power switch in a respective one of the primary side circuits between an input terminal of the isolated SMPS and a primary side reference ground, each of the transformers comprising a secondary winding connected in series with the synchronous rectifier in a respective one of the secondary side circuits between an output terminal of the isolated SMPS and a secondary side reference ground, where N is an integer greater than or equal to 2, wherein:
the isolated control module comprises a primary side control module, an optocoupler and a secondary side control module, the primary side control module connected to control terminals of the power switches, the secondary side control module connected to control terminals of the synchronous rectifiers, the optocoupler connected between the secondary side control module and the primary side control module;
the secondary side control module turns on or off the synchronous rectifiers based on respective N winding voltage signals from the secondary windings in the respective transformers; and
the secondary side control module generates optocoupler drive signals based on the output voltage signal from the isolated SMPS and the respective winding voltage signals, the optocoupler receives the optocoupler drive signals and outputs optocoupler signals to the primary side control module, and the primary side control module generates, based on the optocoupler signals, N pulse-width modulated (PWM) signals staggered in phase from one another and transmits the N PWM signals to the control terminals of the respective power switches to enable staggered control of the N power switches.

2. The isolated SMPS according to claim 1, wherein a turn-on time of each power switch is later than a turn-off time of the respective synchronous rectifier that is connected to the same transformer as the specific power switch.

3. The isolated SMPS according to claim 1, wherein the primary side control module comprises a current threshold and frequency control module and a first logic control module connected to the current threshold and frequency control module,
the current threshold and frequency control module adapted to generate a current threshold and frequency signals based on the optocoupler signals,
the first logic control module adapted to generate the N PWM signals based on the current threshold and the frequency signals.

4. The isolated SMPS according to claim 1, wherein the primary side control module comprises a current threshold and frequency control module and N parallel-connected second logic control modules,
the current threshold and frequency control module adapted to generate a current threshold and frequency signals based on the optocoupler signals,
a first one of the second logic control modules adapted to generate a first one of the PWM signals and (N−1) flag signals, based on the current threshold and the frequency signals,
the remaining (N−1) ones of the second logic control modules adapted to generate the respective remaining ones of the PWM signals based on the respective flag signals.

5. The isolated SMPS according to claim 1, wherein the primary side control module comprises a current threshold and frequency control module and N series-connected second logic control modules,
the current threshold and frequency control module adapted to generate a current threshold and frequency signals based on the optocoupler signals,
a first one of the second logic control modules adapted to generate a first one of the PWM signals and a first flag signal, based on the current threshold and the frequency signals,
a second one of the second logic control modules adapted to generate a second one of the PWM signals and a second flag signal, based on the first flag signal,
an i-th one of the second logic control modules adapted to generate an i-th one of the PWM signals and an i-th flag signal, based on an (i−1)-th flag signal,
an N-th one of the second logic control modules adapted to generate an N-th one of the PWM signals, based on an (N−1)-th flag signal.

6. The isolated SMPS according to claim 3, wherein the frequency signals are adapted for phase staggering of the N PWM signals; the current thresholds are adapted to be compared with currents through the respective N power switches, and when the current in any of the power switches reaches the current threshold, the power switch is turned off; and the primary side control module is also adapted to sample the current in each of the power switches.

7. The isolated SMPS according to claim 1, wherein the secondary side control module comprises a third logic control module and an optocoupler drive module,
the third logic control module connected to an input terminal of the optocoupler drive module, the third logic control module adapted to output first control signals to the optocoupler drive module based on the output voltage signal and the N winding voltage signals,
the optocoupler drive module adapted to convert the first control signals that it receives into optocoupler drive signals for driving the optocoupler.

8. The isolated SMPS according to claim 7, wherein the third logic control module is connected to all the synchronous rectifiers, and
wherein the third logic control module outputs, based on the N winding voltage signals, N second control signals each for turning on or off a respective one of the synchronous rectifiers.

9. The isolated SMPS according to claim 8, wherein the third logic control module is adapted to determine if any of the winding voltage signals reaches a first predetermined value and, if so, turn on the respective synchronous rectifier.

10. The isolated SMPS according to claim 1, further comprising a primary side capacitor and a secondary side capacitor, one end of the primary side capacitor connected to the input terminal of the isolated SMPS, the other end of the primary side capacitor connected to a primary side reference ground,
one end of the secondary side capacitor connected to the output terminal of the isolated SMPS, the other end of the secondary side capacitor connected to a secondary side reference ground.

11. An isolated switched-mode power supply (SMPS) system, comprising:
the isolated SMPS of claim 1; and
a load connected to the output terminal of the isolated SMPS.
